(19) United States
(12) Patent Application Publication
(10) Pub. No.: US 2004/0211368 A1
(43) Pub. Date: Oct. 28, 2004

(54) Auto-deodorant animal cabinet

(76) Inventor: Wen-Chien Chen, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/736,516

(22) Filed: Dec. 17, 2003

(30) Foreign Application Priority Data
Apr. 24, 2003 (TW) 092206466

(51) Int. Cl. A01K 1/02

(52) U.S. Cl. 119/455

(57) ABSTRACT

An auto-deodorant animal cabinet includes an open front end and a plurality of partitions to form several layers within the cabinet. Each partition comprises a slanting board therein. Two sides of each slanting board are connected to a water inlet pipe and a water outlet connected to a water inlet and an exhaust pipe, respectively. Each exhaust pipe is connected to a processing device for grinding process. Each layer of the cabinet comprises a plurality of cages. The cabinet comprises at a back wall a plurality of slots corresponding to each cage. A fan box covering all the slots is provided at the back wall of the said cabinet. The fan box comprises a ventilation pipe with a fan to expel odor smell in the cabinet.

### FIELD OF THE INVENTION

This invention relates to an animal cabinet, and more particularly to a cabinet having several layer spaces to place in cages, and the cabinet is equipped with a good ventilation and clean device.

### BACKGROUND OF THE INVENTION

Many families with pats at home use cages to house their pats at home. This is convenient to keep the house clean. But when it comes to a pat store, an owner needs to have a larger space to take care a lot of animals. They produce massive odor smell. The house has to be an open space to allow the smell flow out of the house. This situation is even worse when an animal is kept in an enclosed room, such as a library or a condo.

Once in a while, the owner needs to wash the cage to maintain a clean and to deodorize the bad smell. This cleaning process takes time and is very limited in effect.

### SUMMARY OF THE INVENTION

It is the primary object of the present invention to provide an anti-odorant animal cabinet, which can clean the cabinet easily and thoroughly.

It is another object of the present invention to provide an anti-odorant animal cabinet, which provides a clean environment.

It is a further object of the present invention to provide an anti-odorant animal cabinet, which saves users' time and water bill.

### BRIEF DESCRIPTION OF THE DRAWINGS

FIG. 1 is a perspective view of the present invention;

FIG. 2 is a perspective view of the present invention, partially sectioned;

FIG. 3 is a view showing an assembled animal cabinet of the present invention;

FIG. 4 is a view depicting cleaning process; and

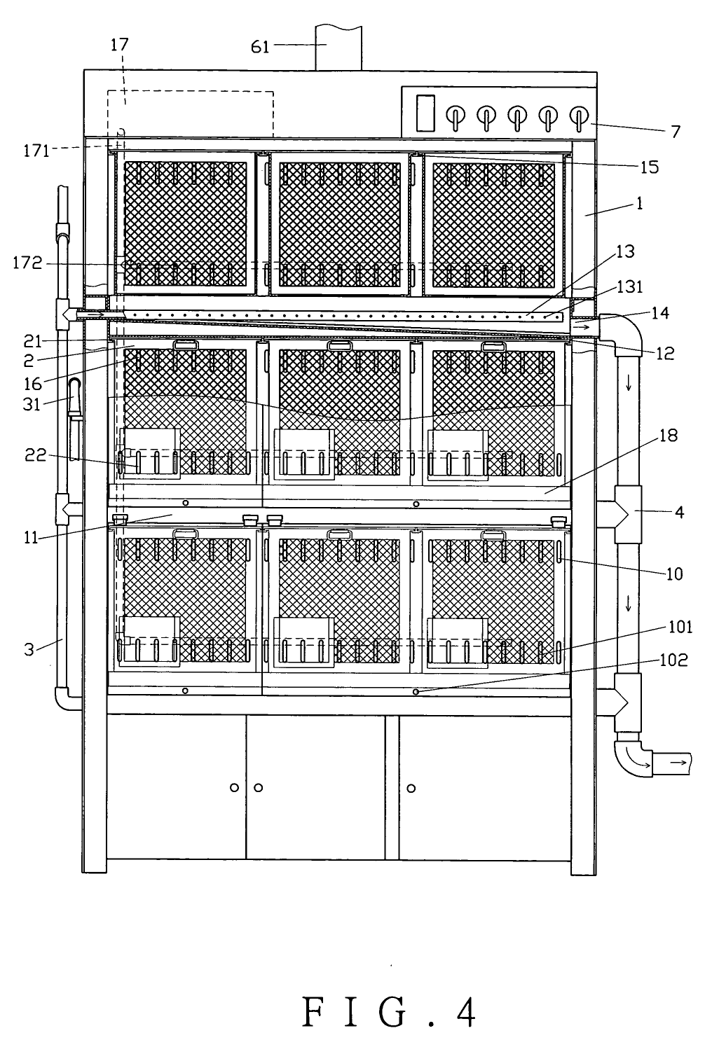

FIG. 5 is a figure showing circulation of the cabinet.

### DETAILED DESCRIPTION OF THE PREFERRED EMBODIMENT

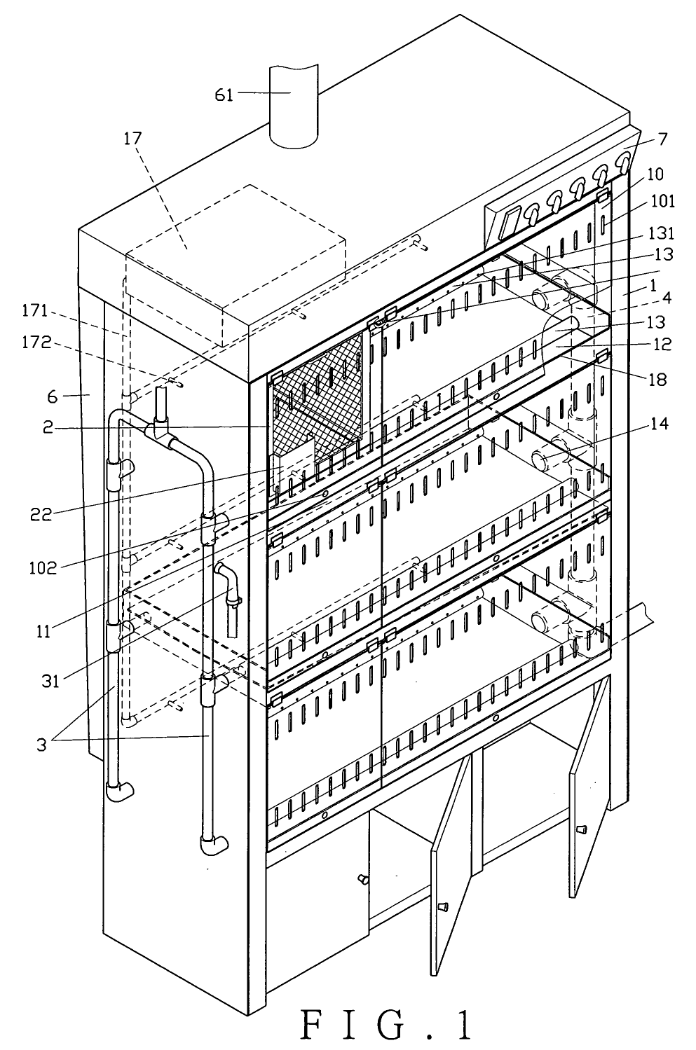

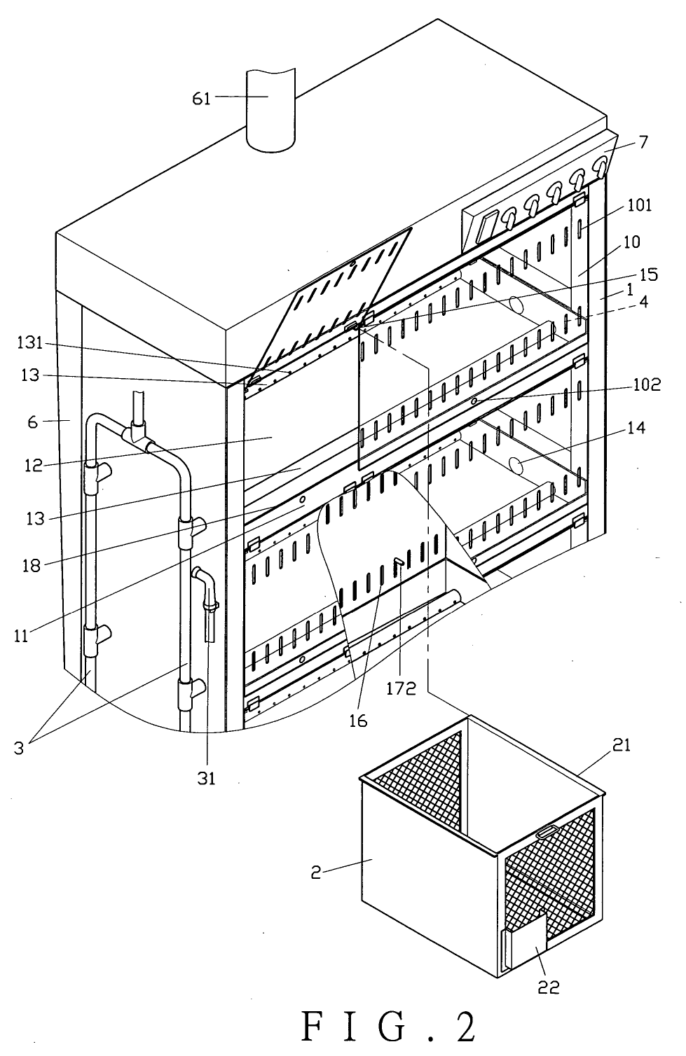

The animal cabinet 1 of the present invention is formed by a number of single cages 2, as shown in FIGS. 1, 2 and 3. All cages 2 are identical with each other. The cabinet 1 is equipped with a good ventilation and clean device, such as a deodorant device 8 to filter odor smell.

The cabinet 1 has an opening front end and comprises a plurality of partitions 11 laid horizontally to form several layers within the cabinet 1. Each layer of the cabinet 1 has a transparent door 10 with holes 101 and a lock 102 thereon to cover the front end of the cabinet 1. Each partition 11 comprises a slanting board 12 corresponding to a water inlet 3 and an exhaust pipe 4, respectively. The slanting board 12 has a higher front and a lower end, and is higher at two sides and lower at the center. Each slanting board 12 is connected to a water inlet pipe 13 and a water outlet 14 at respective sides and then connected to the water inlet 3 and the exhaust pipe 4, respectively. The water inlet pipe 13 comprises two pipes with one at the front end and the other at the rear end of the cabinet 1, respectively. Each pipe 13 has a plurality of outlets 131 for clear water to spread out therefrom. The exhaust pipe 4 is connected to a processing device 5 for grinding process and then flown away with water for further processing and deployed to the sewage pipeline.

Each layer of the cabinet 1 has a pair of equally spaced rails 15 on the inner top wall corresponding to each cage 2 sliding along the rails 15 outwardly.

The rear wall of each layer of the cabinet has a number of slots 16 corresponding to each cage 2. A fan box 6 is provided at the rear wall of the cabinet 1, which covers the entire slots 16. The fan box 6 comprises a ventilation pipe 61, a deodorant processing device 62, and a fan 63 to expel odor smell in the cabinet 1. The deodorant processing device 62 has active carbon to filter the bad air and expel through the ventilation pipe 61. Furthermore, the top of the cabinet 1 has a control box 7 for electrical devices, such as a timer, an automation or a manual operation while the bottom of the cabinet 1 has a storage for food or tools.

Each cage 2 may be designed to have an open top end with a pair of strips 21 on two top sides to be engaged with the pair of rails 15 to hang the cage 2 thereon. The front and rear walls and the bottom of each cage 2 are formed in grids to facilitate drop of excreta. The front wall of each cage 2 has a forage slot 22.

Further, the cabinet 1 has an auto water feeder 17 on the top with a water pipe 171 connected to the water feeder 17. The water pipe 171 comprises a number of water supply manifold 172 connected to each cage 2 for animals in each cage 2 to drink water as needed. The cabinet 1 further comprises a high power pressure spray 31 connected to the water inlet 3 at one side of the cabinet 1.

To operate the present invention, the top end of each cage 2 is open for placing animals in and is covered by the top ceiling of the cabinet 1 or the partition 11. Each cage 2 is slid into the cabinet 1 with the two strips 21 sliding along the rails 15. There is a space 18 between the bottom of each cage 2 and the slanting board 12. The grid bottom of each cage 2 allows excreta to drop therefrom and into the slanting board 12 in the partition 11. The slanting board 12 in the partition 11 is flushed with water from the water inlet 3 through the outlets 131 of the water inlet pipe 13. The dirty water then flows through each water outlet connected to the exhaust pipe 4 into the processing device 5. The processing device 5 will grind all of the excreta into smaller particle and drain into the system. In general, the processing device 5 is located outside of the house. This processing cleans all excreta automatically, that saves manpower and provides better healthy circumstance. The water supply is also controllable through the control box 7.

To prevent any excreta sticking to the bottom of each cage 2, the high power pressure spray 31 extending into each space 18 of the cabinet 1 can wash out the residual excreta.

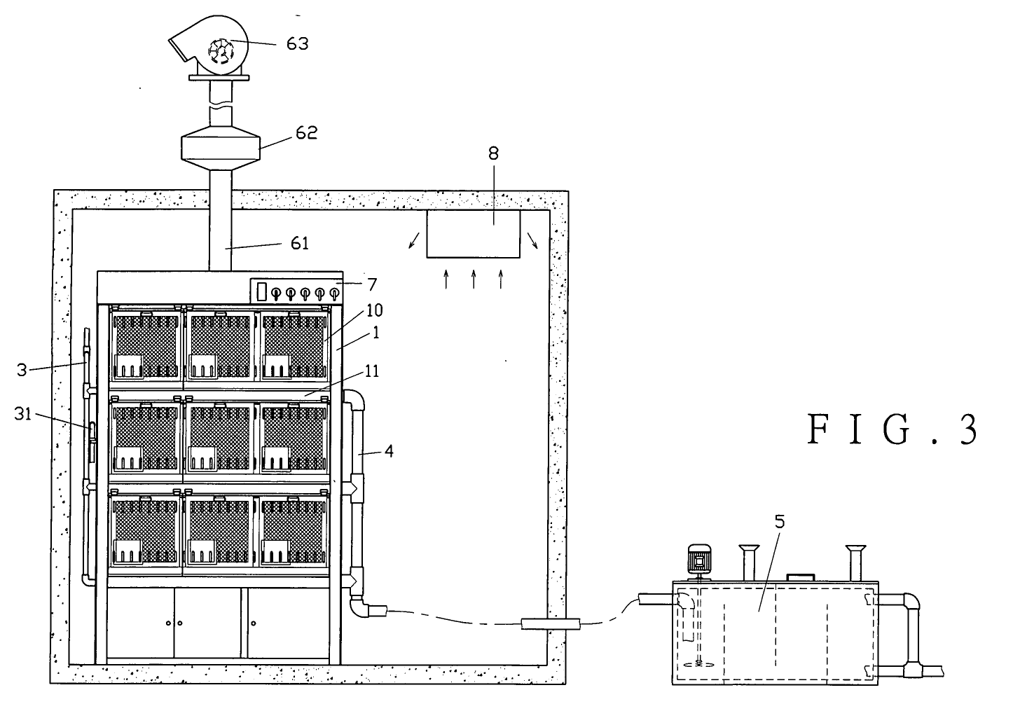

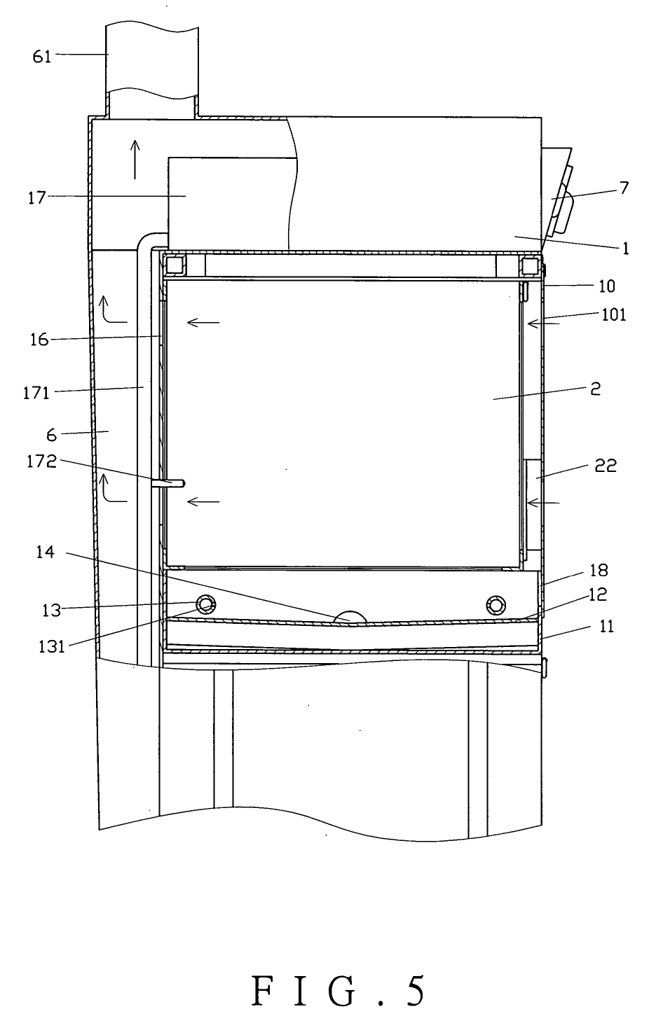

To eliminate the odor smell, the fan box 6, as shown in FIGS. 3 and 5, is a cone shape with a small bottom end and a larger top end. When the fan 63 is activated, the odor smell in the cabinet 1 will be sucked out. The fan 63 can be activated automatically through the control box 7. The cabinet 1 has its back wall covered by the fan box 6 while the front is covered with the door 10 having the holes 101. The fan box 6 is in a cone shape, all air sucked from the cabinet 1 will flow through the open end, thus, the fan 63 provides a strong effect in sucking odor smell. The front and the rear sides of each cage 2 are formed with grids, which is good in ventilation. The fan box 6 is set to activate in a timely basis, along with the deodorant device 8 in a 24-hours operation in the room, almost all odor smell can be eliminated.

Still further, each door 10 of the cabinet 1 has the lock 102 to prevent pulling out the cages 2 randomly.

I claim:

1. An auto-deodorant animal cabinet comprising an open front end and a plurality of partitions to form several layers within said cabinet, each partition comprising a slanting board, two sides of each slanting board being connected to a water inlet pipe and a water outlet connected to a water inlet and an exhaust pipe, respectively, said exhaust pipe being connected to a processing device for grinding process, each layer of said cabinet comprising a plurality of cages, said cabinet comprising at a back wall a plurality of slots corresponding to each cage, a fan box covering all said slots being provided at the back wall of the said cabinet, said fan box comprising a ventilation pipe with a fan to expel odor smell in said cabinet.

2. The auto-deodorant animal cabinet, as recited in claim 1, wherein each layer of said cabinet comprises rails on an inner top wall to hang each cage thereat.

3. The auto-deodorant animal cabinet, as recited in claim 2, wherein each cage comprises an open top end and two strips at two top sides corresponding to said rails, each cage having two plates on two sides and grids on a front and rear ends and a bottom thereof.

4. The auto-deodorant animal cabinet, as recited in claim 1, wherein a lower end of each slanting board is connected to said exhaust pipe.

5. The auto-deodorant animal cabinet, as recited in claim 1, wherein each slanting board is designed in a slanting surface with a high position at a front and rear ends and a lower position at a center.

6. The auto-deodorant animal cabinet, as recited in claim 1, wherein each slanting board has higher positions at two sides and a lower position at the center thereof.

7. The auto-deodorant animal cabinet, as recited in claim 1, wherein each layer of said cabinet is covered with a transparent door with holes thereon, and said door having a lock thereat.
